(19) United States
(12) Patent Application Publication
(10) Pub. No.: US 2019/0237955 A1
(43) Pub. Date: Aug. 1, 2019

(54) POWER DELIVERY ASSEMBLY AND BUILDING HAVING POWER DELIVERY ASSEMBLY

(71) Applicant: Leisure Time Products, LLC, Pittsburg, KS (US)

(72) Inventors: Randall L. Day, Lamar, MO (US); Daniel R. Whyman, Lamar, MO (US)

(21) Appl. No.: 16/256,027

(22) Filed: Jan. 24, 2019

Related U.S. Application Data
(60) Provisional application No. 62/624,275, filed on Jan. 31, 2018.

(51) Int. Cl. H02G 3/38; H02G 3/04; H02H 7/22; H01R 25/00; E04F 10/08

(52) U.S. Cl. CPC H02G 3/386; H02G 3/0437; E04F 10/08; H02H 7/226; H01R 25/006; H02G 3/0418

(57) ABSTRACT

A power delivery assembly includes a fascia panel and a power cable. The fascia panel defines a channel and an outlet opening. The channel extends to the outlet opening. The power cable includes an electrical component, an electrical inlet, and a conductor. The electrical component is disposed in the outlet opening such that the electrical component extends through the fascia panel. The electrical inlet is configured to receive power from a power supply. The conductor is in electrical communication with each of the electrical component and the electrical inlet. The conductor is routed along the channel. The electrical inlet facilitates delivery of electricity through the conductor to the electrical component.

### REFERENCE TO RELATED APPLICATION

This application claims priority of U.S. provisional patent application Ser. No. 62/624,275, entitled Power Delivery Assembly and Building Having Power Delivery Assembly, filed Jan. 31, 2018, and hereby incorporates this provisional patent application by reference herein in its entirety.

### TECHNICAL FIELD

A power delivery assembly for a pergola or other building is provided. The power delivery assembly includes a power cord and a fascia plate.

### BACKGROUND

Conventional outdoor buildings are oftentimes delivered to a site without accommodations for providing power to the outdoor building.

### BRIEF DESCRIPTION OF THE DRAWINGS

It is believed that certain embodiments will be better understood from the following description taken in conjunction with the accompanying drawings in which:

FIG. 1 is an isometric view depicting a pergola having a plurality of vertical posts and a power delivery assembly coupled with one of the vertical posts;

FIG. 2 is an enlarged isometric view depicting the power delivery assembly and one of the vertical posts of FIG. 1;

FIG. 3 is a further enlarged isometric view depicting the power delivery assembly and one of the vertical posts of FIG. 1;

FIG. 4 is an enlarged side isometric view depicting the power delivery assembly and one of the vertical posts of FIG. 1;

FIG. 5 is an enlarged isometric view depicting a cap assembly of the power delivery assembly and vertical posts of FIG. 1, wherein a lid is shown in a closed position;

FIG. 6 is an isometric view depicting the cap assembly of FIG. 5 but with the lid shown in an opened position;

FIG. 7 is a front plan view of a power cable and the cap assembly of the power delivery assembly of FIG. 1;

FIG. 8 is a side elevation view of the power cable and the cap assembly of FIG. 7;

FIG. 9 is a front plan view of the power cable and the cap assembly of FIG. 7 in association with a fascia block plate;

FIG. 10 is a side elevation view of the power cable, the cap assembly, and the fascia block plate of FIG. 9;

FIG. 11 is an isometric view depicting the fascia block plate of FIGS. 9 and 10;

FIG. 12 is a side elevation view depicting the fascia block plate of FIG. 11;

FIG. 13 is a front plan view depicting the fascia block plate of FIG. 11;

FIG. 14 is an isometric view depicting the cap assembly of FIGS. 5 and 6;

FIG. 15 is a front plan view depicting the cap assembly of FIG. 14;

FIG. 16 is an upper elevation view depicting the cap assembly of FIG. 14;

FIG. 17 is a side elevation view depicting the cap assembly of FIG. 14;

FIG. 18 is a rear elevation view depicting the fascia panel of FIG. 1;

FIG. 19A is an enlarged elevation view of the encircled area of FIG. 18;

FIG. 19B is an enlarged elevation view of the encircled area of FIG. 18;

FIG. 20 is an exploded view depicting the power delivery assembly of FIG. 1;

FIG. 21 is an isometric view depicting the pergola of FIG. 1, but with the power delivery assembly shown partially exploded;

FIG. 22A is an enlarged elevation view of the encircled area of FIG. 21;

FIG. 22B is an enlarged elevation view of the encircled area of FIG. 21;

FIG. 23 is a front plan view of a power cable and a cap assembly, in accordance with another embodiment;

FIG. 24 is a side elevation view of the power cable and the cap assembly of FIG. 23; and

FIG. 25 is an enlarged isometric view depicting the power cable and the cap assembly of FIG. 23 in association with a fascia panel and a vertical post of a pergola.

### DETAILED DESCRIPTION

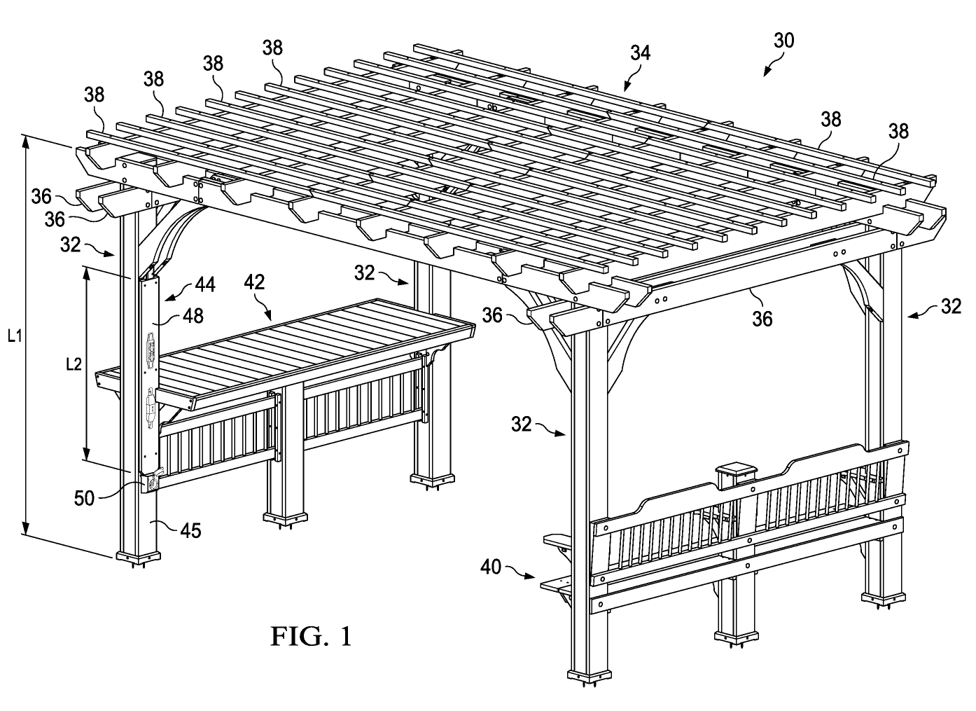

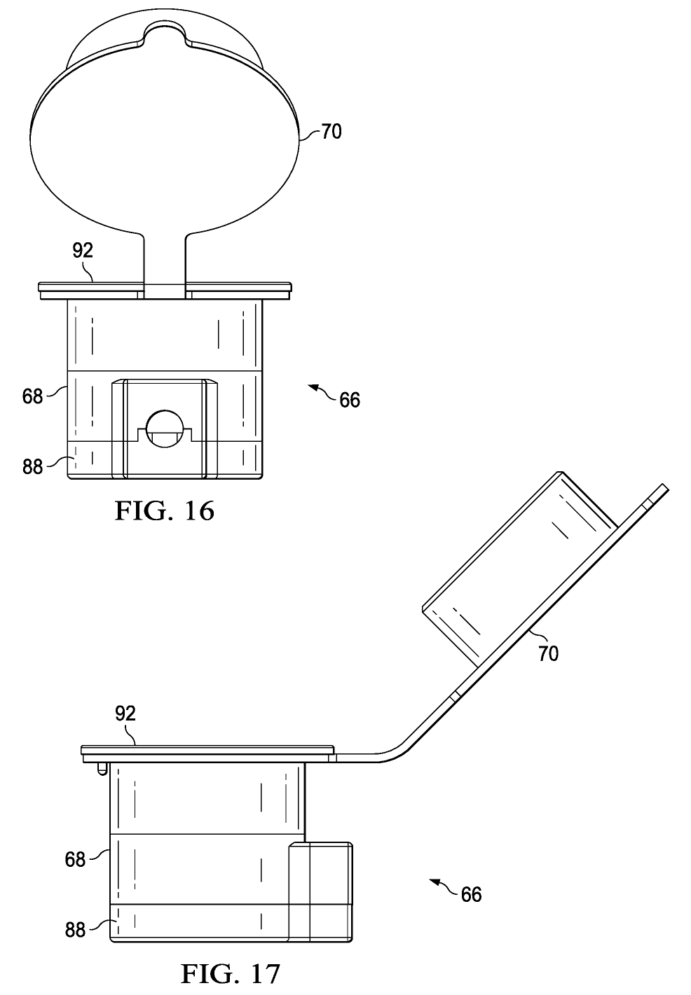

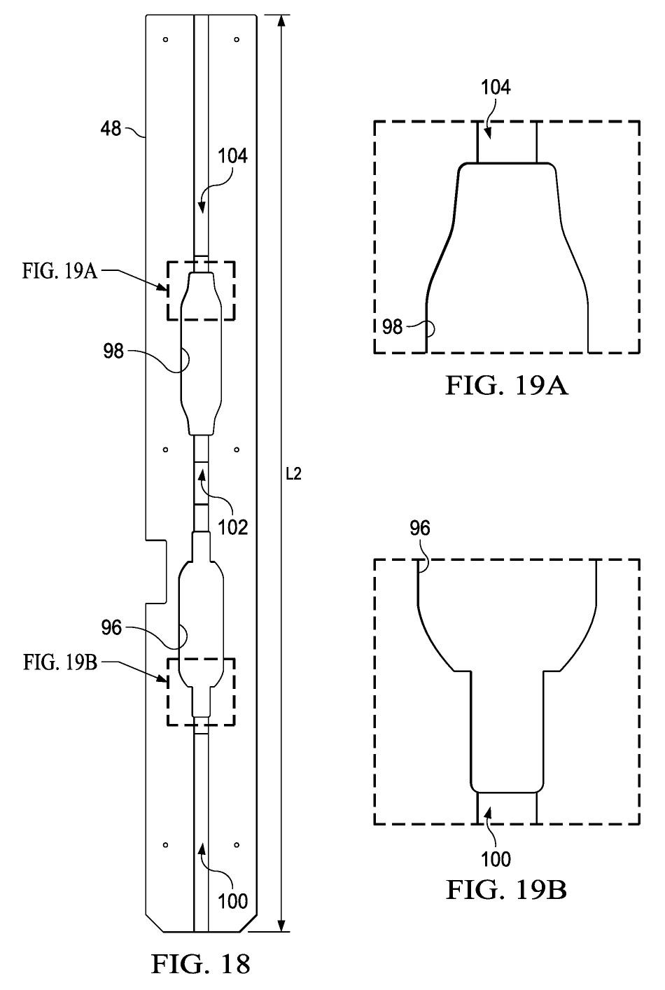

In connection with the views and examples of FIGS. 1-25, wherein like numbers indicate the same or corresponding elements throughout the views, FIG. 1 illustrates a pergola 30 that comprises a plurality of vertical posts 32 and a roof structure 34 (e.g., structural members) that is supported by the vertical posts 32. Each of the vertical posts 32 can have a length L1. The roof structure 34 can comprise a plurality of main beams 36 that cooperate to provide underlying support for a plurality of purlins 38. A bench 40 can extend laterally between and can be coupled with one pair of the vertical posts 32. A table 42 can extend laterally between and can be coupled with another pair of the vertical posts 32.

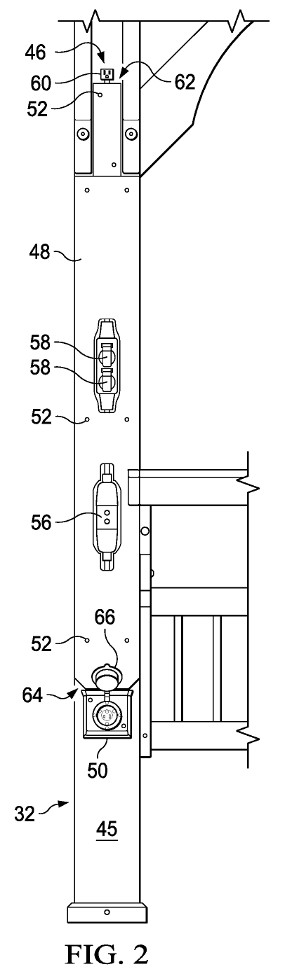

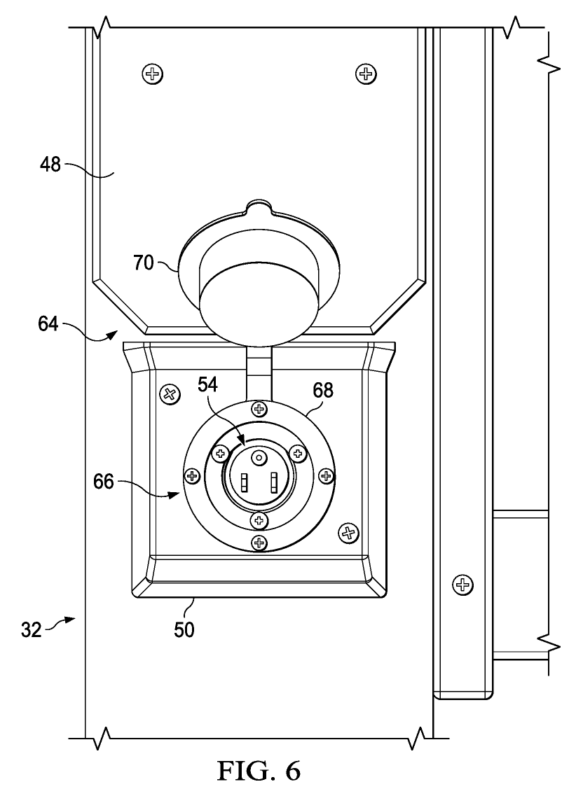

Referring now to FIGS. 1 and 2, a power delivery assembly 44 can be coupled to an exterior surface 45 of one of the vertical posts 32. The power delivery assembly 44 can include a power cable 46 (FIG. 2), a fascia panel 48, and a fascia block plate 50. The fascia panel 48 and the fascia block plate 50 can overlie different portions of the power cable 46 such that the power cable 46 is at least partially sandwiched between the fascia panel 48 and the exterior surface 45 of the vertical post 32 to facilitate securement of the power cable 46 thereto. The fascia panel 48 and the fascia block plate 50 can be fastened to the vertical post 32 by screws 52 or any of a variety of suitable alternative fasteners. The fascia panel 48 can have a length L2 that is less than the length L1 of the vertical post 32 to which the fascia panel 48 is attached. In one embodiment, the fascia panel 48 can have a length L2 that is about ⅔ the length L1 of the vertical post 32 to which the fascia panel 48 is attached. As illustrated in FIG. 2, the power cable 46 can include an electrical inlet 54 (FIG. 6) (e.g., a plug), a ground fault circuit interrupter (GFCI) 56, in-line electrical outlets 58, and a terminated electrical outlet 60 that can all be in electrical communication with each other. It is to be appreciated that the power delivery assembly 44 being coupled with the exterior surface 45 can be understood to mean that that the power delivery assembly 44 overlies the exterior surface 45 and resides entirely outside of an interior (not shown) of the vertical post 32.

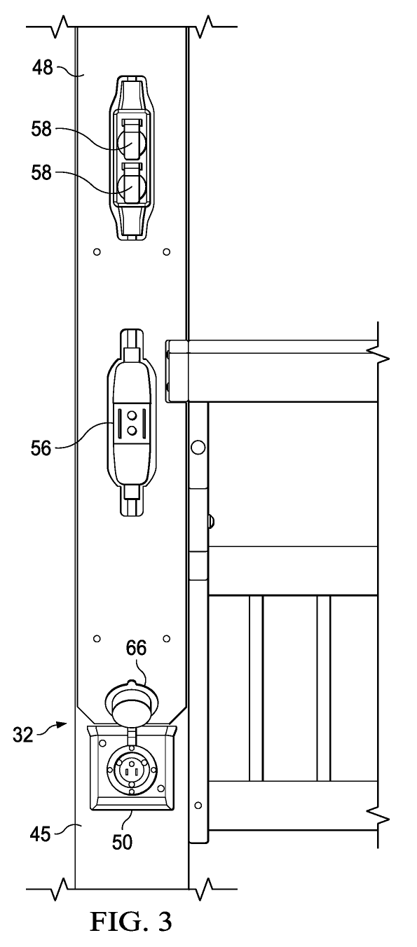

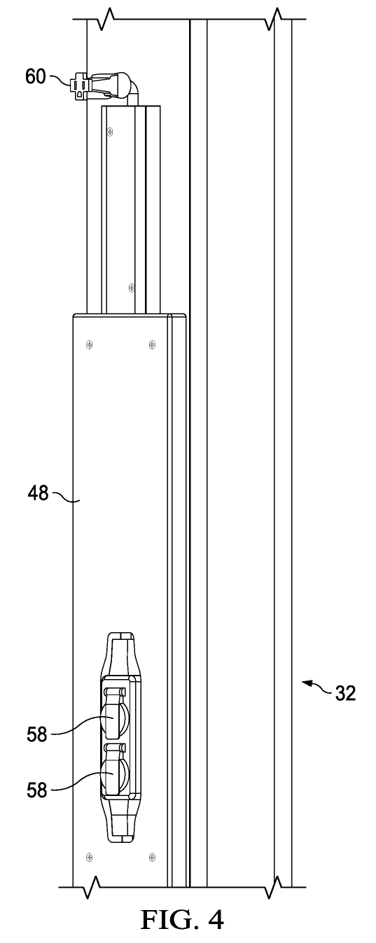

Referring now to FIG. 3, the GFCI 56 and the in-line electrical outlets 58 can be disposed in the fascia panel 48 and can extend therethrough such that the GFCI 56 and the in-line electrical outlets 58 are accessible to a user. Referring now to FIG. 4, the terminated electrical outlet 60 can extend from an upper end 62 of the fascia panel 48 to allow for a corded electrical device, such as a string of lights or an extension cord, to be plugged into the terminated electrical outlet 60. The location of the terminated electrical outlet 60 at the upper end 62 of the fascia panel 48 can provide the terminated electrical outlet 60 at a location that is proximate the roof structure 34, which can enable stranded lights or other electrical devices to be easily routed near or onto the roof structure 34.

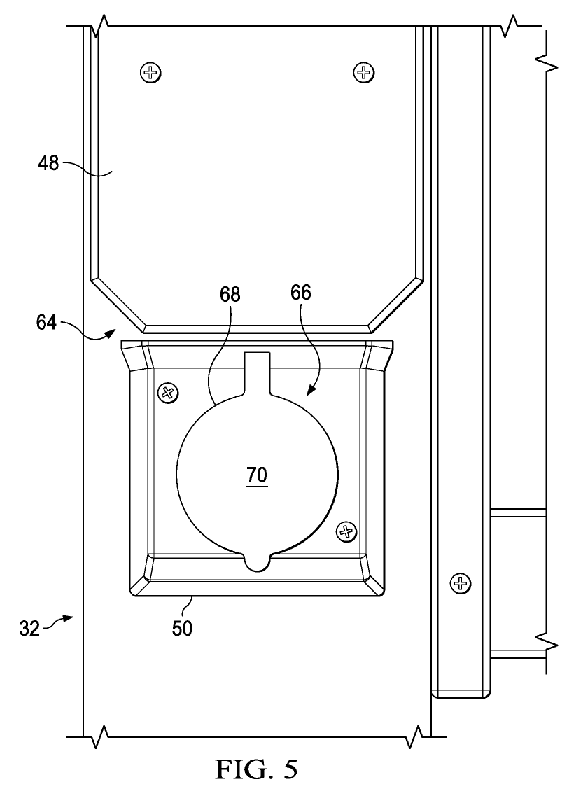

Referring now to FIGS. 5 and 6, the electrical inlet 54 (FIG. 6) can be disposed in the fascia block plate 50 such that the electrical inlet 54 is accessible to a user. The fascia block plate 50 and the electrical inlet 54 can be located at a lower end 64 of the fascia panel 48 to allow for a power supply, such as an energized extension cord, to be plugged into the electrical inlet 54 to distribute electrical power to the rest of the power cable 46. The location of the electrical inlet 54 at the lower end 64 of the fascia panel 48 can provide the electrical inlet 54 at a location that is proximate a ground surface to allow for ease of access to the electrical inlet 54 when plugging a power supply (not shown) into the electrical inlet 54. The electrical inlet 54 can comprise a male plug that is configured to receive a female plug from a power supply to facilitate the delivery of electricity to the rest of the power cable 46. It is to be appreciated that although the electrical inlet 54 is described as being a male input, any of a variety of different electrical plug types and/or combinations of different plug types are contemplated.

A cap assembly 66 can be associated with the electrical inlet 54 and can comprise a body 68 and a lid 70. The lid 70 can be moved between a closed position (FIG. 5) and an opened position (FIG. 6) to facilitate selective access to the electrical inlet 54. When the lid 70 is in the closed position (FIG. 5), the body 68 and the lid 70 can cooperate with each other to protect the electrical inlet 54 from exposure to environmental conditions (e.g., rain). When the lid 70 is in the opened position (FIG. 6), the electrical inlet 54 can be exposed to allow a power supply (not shown) to be plugged into the electrical inlet 54. In one embodiment, as illustrated in FIGS. 5 and 6, the lid 70 can be hingedly coupled with the body 68, but in other embodiments, the lid 70 can be movably coupled with the body 68 in any of a variety of suitable alternative arrangements (e.g., removable from the body 68).

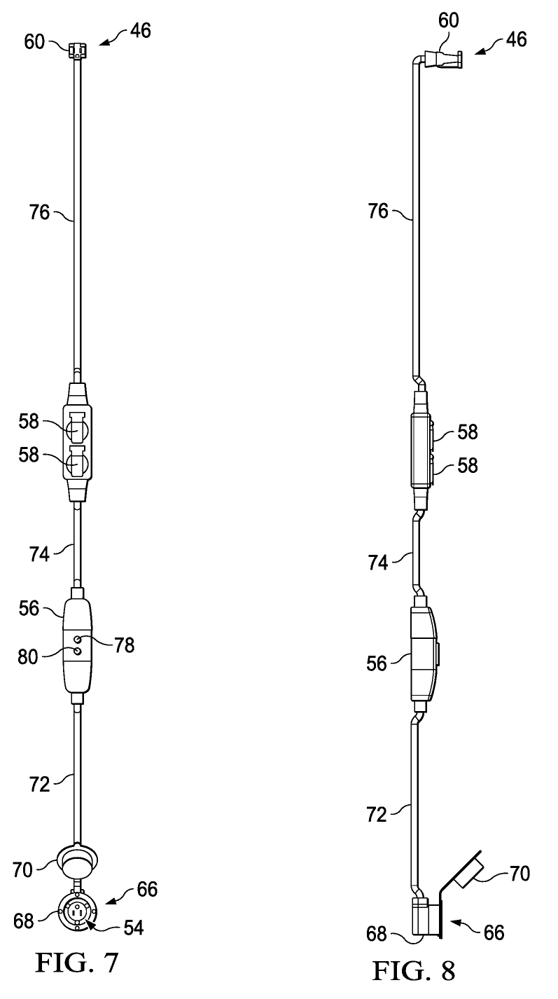

Referring now to FIGS. 7 and 8, the power cable 46 will now be described. The electrical inlet 54, the GFCI 56, the in-line electrical outlets 58, and the terminated electrical outlet 60 can be in electrical communication with each other via respective conductors 72, 74, 76. The GFCI 56 can be immediately downstream of the electrical inlet 54 and can be configured to facilitate selective electrical disconnection of the electrical inlet 54 from the in-line electrical outlets 58 and the terminated electrical outlet 60 (e.g., when the in-line electrical outlets 58 and the terminated electrical outlet 60 are exposed to moisture). The GFCI 56 can comprise a TEST button 78 and a RESET button 80 that can be manually depressed (e.g., by a user) to allow for testing and resetting, respectively, of the GFCI 56. The in-line electrical outlets 58 can be immediately downstream of the GFCI 56 and can be female outlets that are each configured to receive a male plug from an electrical device for delivery of electricity thereto. In one embodiment, the power cable 46 can include an electrical switch (not shown) that facilitates selective manual disconnection of the in-line electrical outlets 58 from the electrical inlet 54. Although two in-line electrical outlets 58 are shown, it is to be appreciated that any quantity of in-line electrical outlets (e.g., one or more than two) can be provided. It is also to be appreciated that although the in-line electrical outlets are described as being female outlets, any of a variety of different electrical plug types and/or combinations thereof are contemplated. The terminated electrical outlet 60 can be immediately downstream of the in-line electrical outlets 58 and can be a female outlet that is configured to receive a male plug from an electrical device for delivery of electricity thereto. Although one terminated electrical outlet 60 is shown, it is to be appreciated that any quantity of terminated electrical outlets (e.g., more than one) can be provided. It is also to be appreciated that although the terminated electrical outlet 60 is described as being a female outlet, any of a variety of different electrical plug types and/or combinations thereof are contemplated.

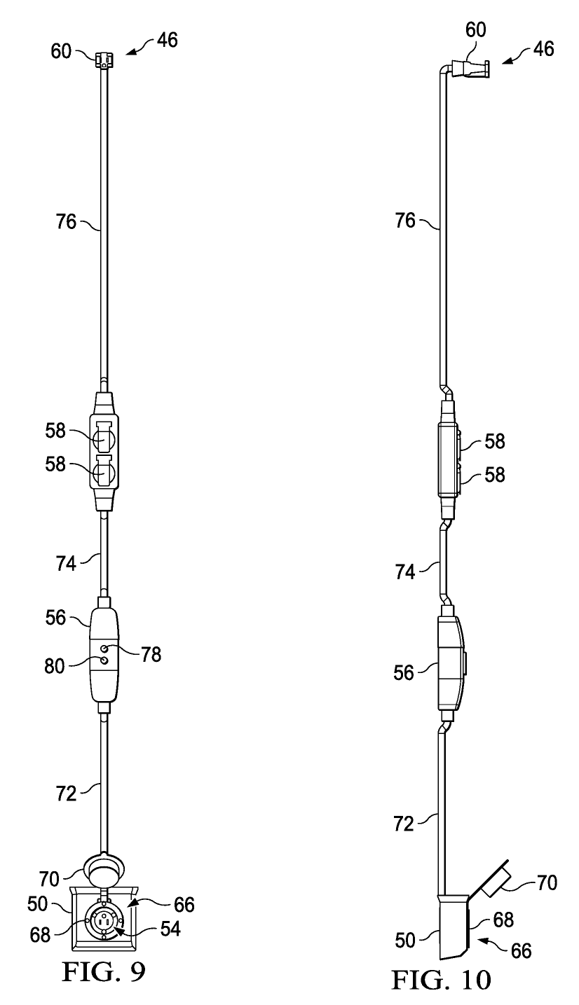

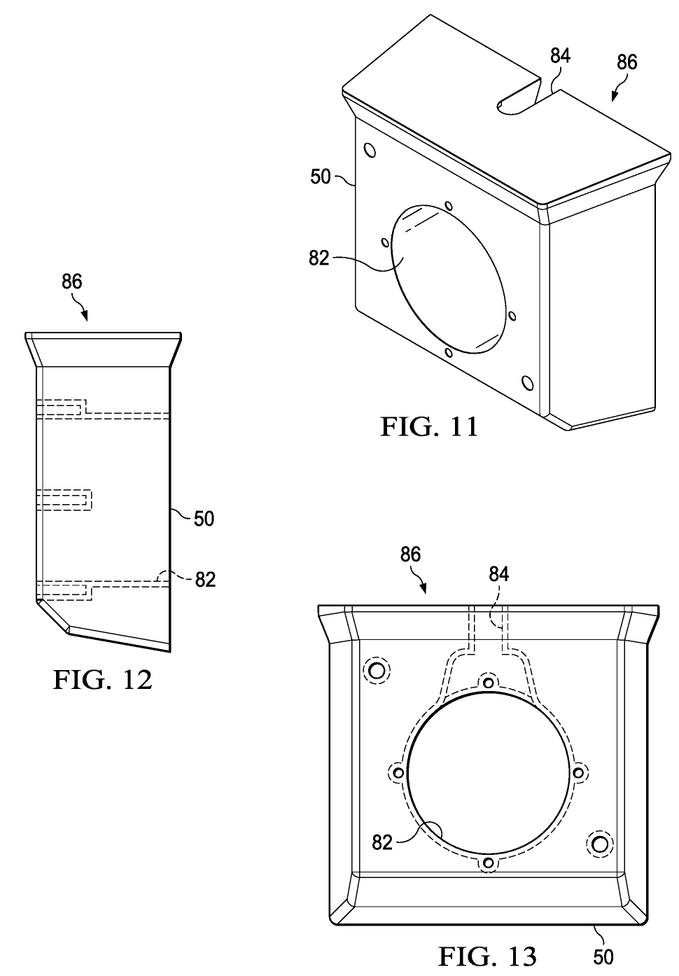

Referring now to FIGS. 9 and 10, the electrical inlet 54 and the cap assembly 66 are shown to be installed onto the fascia block plate 50. Referring now to FIGS. 11-13, the fascia block plate 50 can define a central receptacle 82 and a channel 84 that extends between an upper portion 86 of the fascia block plate 50 and the central receptacle 82. The central receptacle 82 can be configured to receive the electrical inlet 54 and the cap assembly 66. The channel 84 can be configured to receive the conductor 72 of the power cable 46.

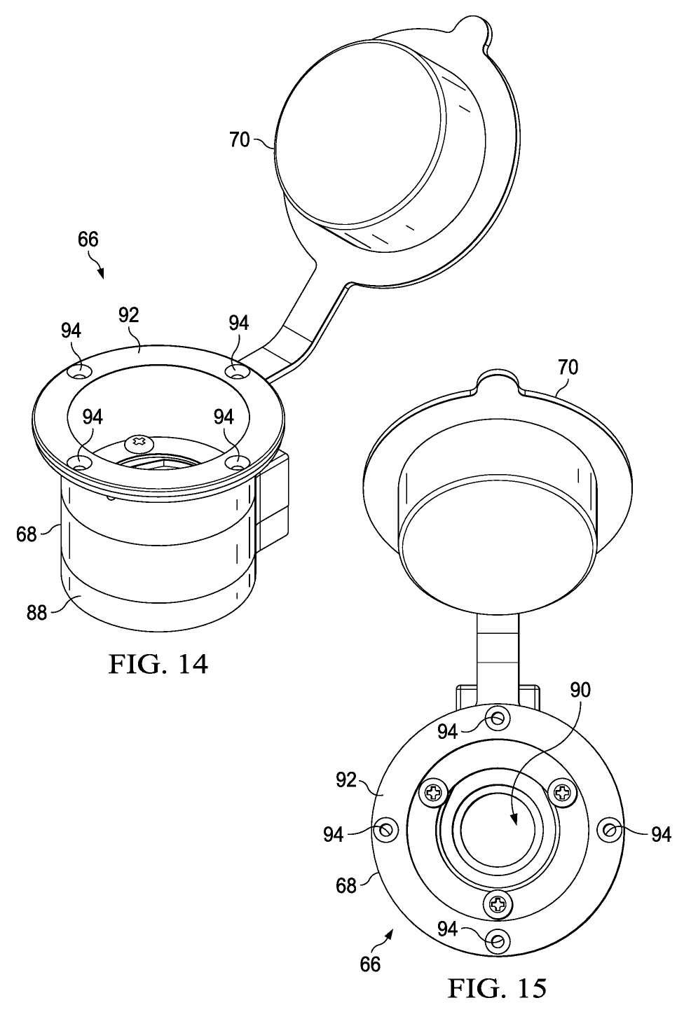

Referring now to FIGS. 14-17, the body 68 of the cap assembly 66 can include a collar 88 that defines a main opening 90 (FIG. 15) that is configured to receive the electrical inlet 54. A flange 92 can extend laterally from the collar 88 and can define a plurality of through holes 94 (FIGS. 14 and 15). When the cap assembly 66 is installed on the fascia block plate 50, the collar 88 can extend into the central receptacle 82, and the flange 92 can overlie a portion of the fascia block plate 50 adjacent to the central receptacle 82. Fasteners (not shown) can be provided into the through holes 94 to facilitate securement of the cap assembly 66 to the fascia block plate 50. The electrical inlet 54 can be inserted into the main opening 90, and the conductor 72 can be routed through the channel 84 such that the electrical inlet 54 and the conductor 72 are embedded in the fascia block plate 50 to allow for flush mounting of the fascia block plate 50 to the vertical post 32.

Referring now to FIGS. 18, 19A and 19B, the fascia panel 48 can define a GFCI opening 96 and an outlet opening 98 that are configured to receive the GFCI 56 and the in-line electrical outlets 58, respectively. The fascia panel 48 can define a lower channel 100, a central channel 102, and an upper channel 104. The lower channel 100 can extend between the lower end 64 of the fascia panel 48 and the GFCI opening 96 and can be configured to receive the conductor 72 (see FIG. 19B). The central channel 102 can extend between the GFCI opening 96 and the outlet opening 98 and can be configured to receive the conductor 74. The upper channel 104 can extend from the outlet opening 98 to the upper end 62 of the fascia panel 48 and can be configured to receive the conductor 76 (see FIG. 19A). It is to be appreciated that although the GFCI 56 and the electrical outlets 58 are described as being disposed in the openings 96, 98, any of a variety of suitable alternative electrical components can be housed by the fascia panel 48 (e.g., disposed in the openings 96, 98), such as, for example, an electronic key pad, a light switch, a light, or a volume knob.

When the power cable 46 is routed along the fascia panel 48, the GFCI 56 can be disposed in the GFCI opening 96, the in-line electrical outlets 58 can be disposed in the outlet opening 98, the conductor 72 can be embedded in the lower channel 100, the conductor 74 can be embedded in the central channel 102, and the conductor 76 can be embedded in the upper channel 104 to allow for flush mounting of the fascia panel 48 to the vertical post 32.

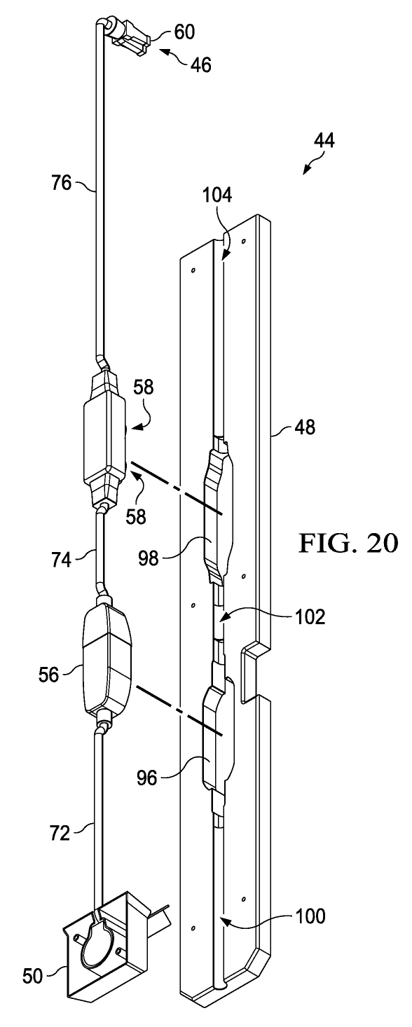

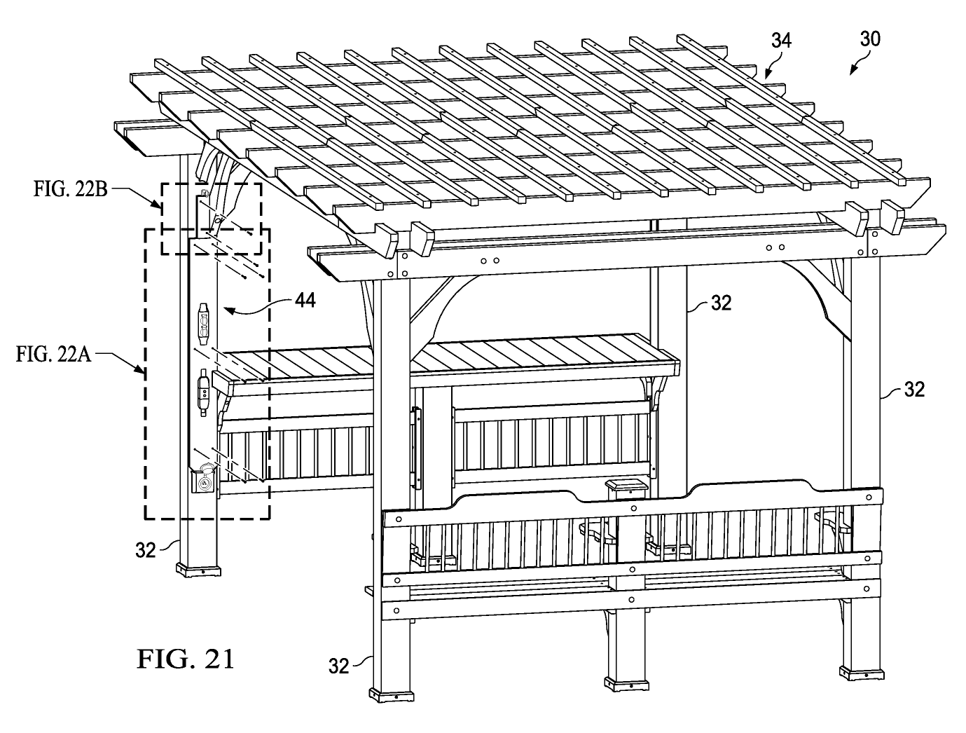

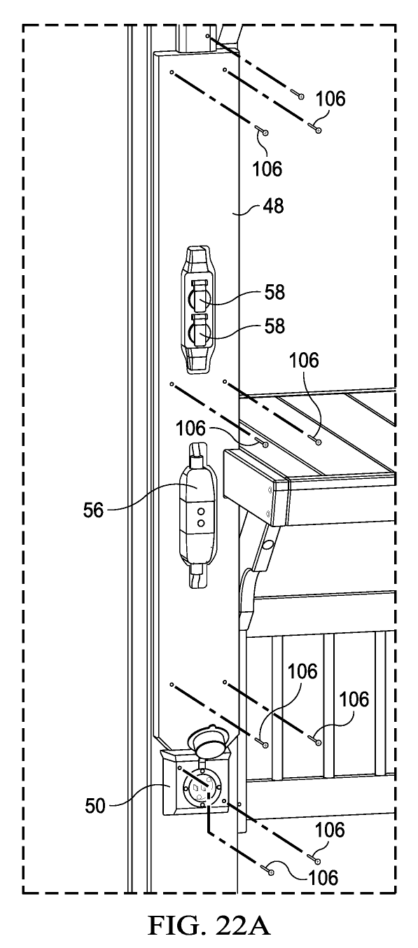

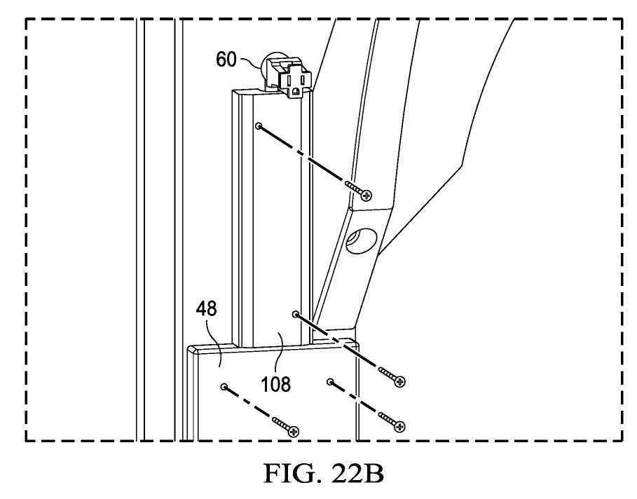

Referring now to FIGS. 20, 21, 22A and 22B, one method of assembling the pergola 30 of FIG. 1 will now be described. First, the plurality of vertical posts 32 can be installed on a ground surface, and the roof structure 34 can be installed above the vertical posts 32. The power cable 46 can then be installed into the fascia panel 48 such that portions of the power cable 46 are embedded in the fascia panel 48, as described above and with respect to FIG. 20. The cap assembly 66 can then be installed onto the fascia block plate 50, and the electrical inlet 54 can be inserted into the main opening 90. The conductor 72 can then be routed through the channel 84 such that the conductor 72 is embedded in the fascia block plate 50. The fascia panel 48 and the fascia block plate 50 can then be secured to the desired vertical post 32 with fasteners 106, as illustrated in FIGS. 21 and 22A. An upper shield 108 (FIG. 22B) can then be installed over the conductor 76 at the upper end 62 of the fascia panel 48 and secured to the vertical post 32 to position the terminated electrical outlet 60 relative to the vertical post 32. In this manner, the fascia panel 48, the fascia block plate 50, and the upper shield 108 can cooperate to facilitate attachment of the power cable 46 to the vertical post 32. It is to be appreciated that, by providing the fascia panel 48, the fascia block plate 50, and the upper shield 108 as separate components, the power cable 46 can be assembled to the pergola 30 more easily and the pergola 30 can be more easily manufactured than conventional arrangements. However, in other embodiments, the fascia panel 48, the fascia block plate 50, and the upper shield 108 can be provided as one component (e.g., in a unitary one-piece construction), two components or more than three components.

In one embodiment, the power delivery assembly 44 provides no structural support to the pergola 30 or roof structure 34. It is to be appreciated that although a pergola is described herein, a power delivery assembly (e.g., 44) as described herein can be provided on a vertical post or other feature of any of a variety other suitable structures, such as a shed, a gazebo, a trellis, a platform shelter, a canopy, a pavilion, a tent or an awning, for example.

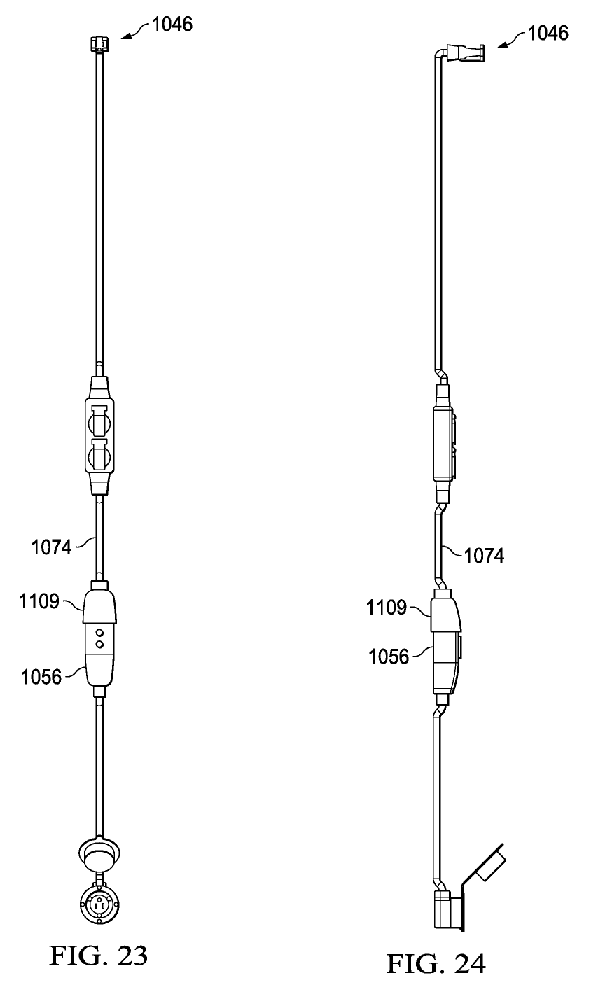

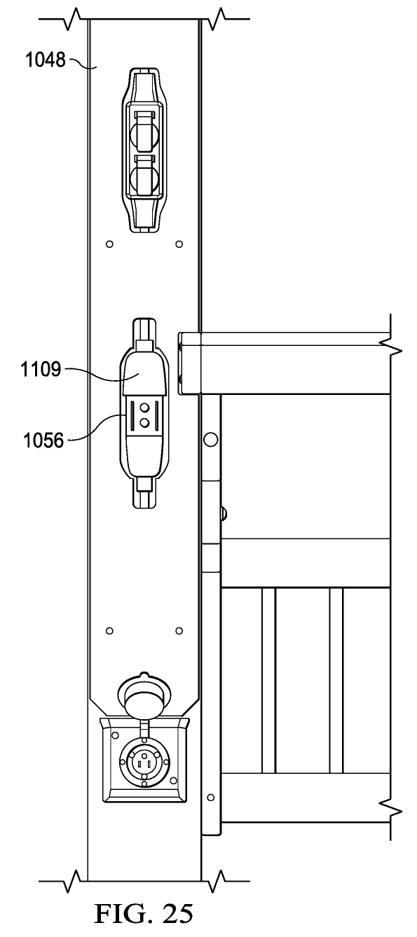

FIGS. 23-25 illustrate an alternative embodiment of a power cable 1046 that is similar to, or the same as in many respects as, the power cable 46 in FIGS. 1-22B. For example, the power cable 1046 can include a GFCI 1056 and a conductor 1074. However, the power cable 1046 can include a sleeve 1109 that is provided over a portion of the conductor 1074 and an upper portion of the GFCI 1056. When the power cable 1046 is installed in a fascia panel 1048 (see FIG. 25), the sleeve 1109 can facilitate the deflection of precipitation (e.g., rain or snow) away from the GFCI 1056. In one embodiment, the sleeve 1109 can be formed of an elastomeric material (e.g., rubber) and can be formed (e.g., thermoformed) onto the conductor 1074 to create a substantially impervious seal therebetween. It is to be appreciated that the sleeve 1109 can be formed of any of a variety of suitable alternative materials that are sealably coupled with the conductor 1074.

It is to be appreciated that although a pergola (e.g., 30) is shown and described herein, the power delivery assembly 44 can be used on any of a variety of suitable alternative buildings, such as a gazebo, an arbour, a shed, a pavilion, a pole barn, a house, or a high rise building, for example.

The foregoing description of embodiments and examples of the disclosure has been presented for purposes of illustration and description. It is not intended to be exhaustive or to limit the disclosure to the forms described. Numerous modifications are possible in light of the above teachings. Some of those modifications have been discussed and others will be understood by those skilled in the art. The embodiments were chosen and described in order to best illustrate the principles of the disclosure and various embodiments as are suited to the particular use contemplated. The scope of the disclosure is, of course, not limited to the examples or embodiments set forth herein, but can be employed in any number of applications and equivalent devices by those of ordinary skill in the art. Rather it is hereby intended the scope of the invention be defined by the claims appended hereto. Also, for any methods claimed and/or described, regardless of whether the method is described in conjunction with a flow diagram, it should be understood that unless otherwise specified or required by context, any explicit or implicit ordering of steps performed in the execution of a method does not imply that those steps must be performed in the order presented and may be performed in a different order or in parallel.

What is claimed is:

1. A building comprising:
at least one structural member; and
a power delivery assembly coupled with the at least one structural member, the power delivery assembly comprising:
a fascia panel defining a first channel and an outlet opening, the first channel extending to the outlet opening;
a power cable comprising:
an electrical component disposed in the outlet opening such that the electrical component extends through the fascia panel;
an electrical inlet configured to receive power from a power supply; and
a conductor in electrical communication with each of the electrical component and the electrical inlet, wherein:
the conductor is routed along the first channel; and
the electrical inlet facilitates delivery of electricity through the conductor to the electrical component.

2. The building of claim 1 wherein the electrical component comprises one of a ground fault circuit interrupter, an in-line electrical outlet, and a terminated electrical outlet.

3. The building of claim 1 wherein the power delivery assembly further comprises a fascia block plate coupled with the at least one structural member, the fascia block plate defining a receptacle and a second channel, the electrical inlet being inserted into the receptacle and the conductor being routed through the second channel.

4. The building of claim 3 wherein the power delivery assembly further comprises a cap assembly comprising a body and a lid, wherein:
the body is disposed in the receptacle;
the electrical inlet is disposed in the body; and
the lid is selectively movable relative to the body between an opened position and a closed position.

5. The building of claim 1 wherein the at least one structural member comprises:
a plurality of support posts, one support post of the plurality of support posts comprising a first length; and
a roofing structure coupled to and overlying the plurality of support posts, wherein the power delivery assembly is coupled with an exterior surface of the one support post.

6. The building of claim 5 wherein the fascia panel comprises a second length that is less than the first length.

7. The building of claim 6 wherein the second length is less than ⅔ as long as the first length.

8. A power delivery assembly comprising:
a fascia panel defining a first channel and a first outlet opening, the first channel extending to the first outlet opening;
a power cable comprising:
a first electrical component disposed in the first outlet opening such that the first electrical component extends through the fascia panel;
an electrical inlet configured to receive power from a power supply; and
a first conductor in electrical communication with each of the first electrical component and the electrical inlet, wherein:
the first conductor is routed along the first channel; and
the electrical inlet facilitates delivery of electricity through the first conductor to the first electrical component.

9. The power delivery assembly of claim 8 wherein:
the fascia panel further defines a second channel and a second outlet opening, the second channel extending between the first outlet opening and the second outlet opening;
the power cable further comprises:
a second electrical component disposed in the second outlet opening such that the second electrical component extends through the fascia panel; and
a second conductor in electrical communication with each of the first electrical component and the second electrical component;
the second conductor is routed along the second channel; and
the electrical inlet facilitates delivery of electricity through the second conductor to the second electrical component.

10. The power delivery assembly of claim 9 wherein the first electrical component comprises a ground fault circuit interrupter and the second electrical component comprises an electrical outlet.

11. The power delivery assembly of claim 9 wherein:
the fascia panel further defines a third channel extending from the second outlet opening;
the power cable further comprises:
a third electrical component; and
a third conductor in electrical communication with each of the second electrical component and the third electrical component;
the third conductor is routed along the third channel; and
the electrical inlet facilitates delivery of electricity through the third conductor to the third electrical component.

12. The power delivery assembly of claim 11 wherein the first electrical component comprises a ground fault circuit interrupter, the second electrical component comprises an electrical outlet, and the third electrical component comprises an electrical outlet.

13. The power delivery assembly of claim 8 further comprising a fascia block plate that defines a receptacle and a second channel, the electrical inlet being inserted into the receptacle and the first conductor being routed through the second channel.

14. The power delivery assembly of claim 13 further comprising a cap assembly comprising a body and a lid, wherein:
the body is disposed in the receptacle;
the electrical inlet is disposed in the body; and
the lid is selectively movable relative to the body between an opened position and a closed position.

15. A building comprising:
a plurality of support posts;
a roofing structure coupled to and overlying the plurality of support posts;
a power delivery assembly coupled with an exterior surface of one support post of the plurality of support posts, the power delivery assembly comprising:
a fascia panel defining a first channel, a second channel, and a first outlet opening and a second outlet opening, the first channel extending to the first outlet opening and the second channel extending between the first channel and the second channel;
a power cable comprising:
a ground fault circuit interrupter disposed in the first outlet opening such that the ground fault circuit interrupter extends through the fascia panel;
an electrical outlet disposed in the second outlet opening such that the electrical outlet extends through the fascia panel;
an electrical inlet configured to receive power from a power supply;
a first conductor in electrical communication with each of the ground fault circuit interrupter and the electrical inlet; and
a second conductor in electrical communication with each of the ground fault circuit interrupter and the electrical outlet, wherein:
the first conductor is routed along the first channel;
the second conductor is routed along the second channel; and
the electrical inlet facilitates delivery of electricity through the first conductor to the ground fault circuit interrupter and through the second conductor to the electrical outlet.

16. The building of claim 15 wherein:
the fascia panel further defines a third channel extending from the second outlet opening;
the power cable further comprises:
a third electrical component; and
a third conductor in electrical communication with each of the electrical outlet and the third electrical component;
the third conductor is routed along the third channel; and
the electrical inlet facilitates delivery of electricity through the third conductor to the third electrical component.

17. The building of claim 16 wherein the third electrical component comprises an electrical outlet.

18. The building of claim 15 further comprising a fascia block plate that defines a receptacle and a third channel, the electrical inlet being inserted into the receptacle and the first conductor being routed through the third channel.

19. The building of claim 18 further comprising a cap assembly comprising a body and a lid, wherein:
the body is disposed in the receptacle;
the electrical inlet is disposed in the body; and
the lid is selectively movable relative to the body between an opened position and a closed position.

20. The building of claim 15 wherein the power cable further comprises a sleeve that is provided over a portion of the first conductor and a portion of the ground fault circuit interrupter.
